(19) United States
(12) Patent Application Publication
(10) Pub. No.: US 2009/0135194 A1
(43) Pub. Date: May 28, 2009

(54) OPTIMIZED DISPLAY OF MEDICAL IMAGES ON A LARGE-FORMAT DISPLAY UNIT

(76) Inventor: Bernd Keuenhof, Kleinsendelbach (DE)

Correspondence Address: BRINKS HOFER GILSON & LIONE, P.O. BOX 10395, CHICAGO, IL, 60610, US

(21) Appl. No.: 12/272,386

(22) Filed: Nov. 17, 2008

(30) Foreign Application Priority Data
Nov. 23, 2007 (DE) 10 2007 056 432.7

(51) Int. Cl. G09G 5/00

(52) U.S. Cl. 345/581

(57) ABSTRACT

A device for controlling the display of medical images on a large-format display unit is provided. The device includes a number of programs, which are assigned respectively to a medical workflow. The programs are configured for control of the display on the large-format display unit according to the associated workflow and can be called up by selecting the workflow. Accordingly, the display on a large-format display unit may be controlled according to medical workflows.

This patent document claims the benefit of German Patent Application No. DE 10 2007 056 432.7 filed on Nov. 23, 2007, which is hereby incorporated by reference.

### BACKGROUND

The present embodiments relate to controlling a display of medical images on a large-format display unit.

Medical examinations in a hospital may include using a number of displays and/or images to capture the examined part of the body. A number of different perspectives can be displayed, for example, using a medical imaging method. Different imaging methods and/or modalities (e.g. x-ray, computed tomography, ultrasound, magnetic resonance tomography, video, laser beam scatter, etc.) are combined to obtain as much information as possible about the patient's health problems. A number of displayed images are used, when images recorded under different conditions (e.g. before and after the assimilation of contrast agents) are superimposed, to obtain a display with the greatest possible contrast (differential methods).

Different medical images are generally displayed respectively on individual, dedicated image reproduction devices. A separate image reproduction device is required for each video (graphics card) output of a medical imaging system. As a result eight or even more image reproduction devices are required in the examination room with modern x-ray system examination stations, including, for example, color displays for ECG and ultrasound.

A solution with a number of display units is unclear, inflexible and not easily scalable. “New Display Solutions for the Image-Centric Era of Healthcare” by S. Bonfiglio and L. Albani in SID Symposium Digest of Technical Papers—May 2007—Volume 38, Issue 1, pp. 123-126, discloses that a number of medical images may be displayed on a large-format display unit, so that it is possible to manage the medical images with one display unit per examination station. This publication describes an input device, which can be used to select images to be displayed on a large-format display unit from a plurality of possible medical images. The input device (e.g., a tablet PC) has a display, which has a first region with selectable images and a second region showing the images displayed on the large-format display unit. An image is selected by pushing the image from the first into the second region, whereupon it is displayed on the large-format display unit.

### SUMMARY AND DESCRIPTION

The present embodiments may obviate one or more of the drawbacks or limitations inherent in the related art. For example, in one embodiment, medical image combinations may be optimally displayed on a large-format display unit.

In one embodiment, a number of programs are provided to control the display on a large-format display unit. The programs are assigned respectively to a medical workflow and serve to control the display on a large-format display unit to support the medical workflow.

A program may be a sequence of instructions, which are suitable for execution on a computer, for example, a computer program. The term “program” is however not intended to make a statement about the possible structure of suitable software. Sub-routines or sub-programs may correspond to the programs in respect of the structure of the software, these being called up by a different program part.

A medical workflow may be a sequence (e.g. work sequence or process sequence) during the treatment or examination of patients in a hospital. The workflow can also be defined implicitly, for example, in that organs or parts of the body to be examined or treated can be selected by the physician and a corresponding program is started, with the examination and/or treatment of the organ and/or part of the body corresponding to a defined workflow.

The display may be controlled according to requirements for the display of images arising during the workflow (and/or the corresponding examination or treatment). The requirements relate, for example, to the perspective, the type, the number, the arrangement or the processing of the images displayed. The display may be dynamically modified according to the workflow, for example, by updating images (for example, during the display of a stream of images) or displayed information or by adjusting the image combination shown on the large-format display unit, for example perspective, type, number, arrangement and processing of the images displayed. An update can also be triggered, for example, by the start of a new segment or act of a treatment or examination being carried out. A manual trigger (e.g., input at an input device) or an automatic trigger (e.g., automatic identification mechanism for the start of a new segment) can be provided for the input.

The large-format display unit or large-format screen may be an image reproduction device, a display unit, a monitor, or a display, which with respect of its technical characteristics (e.g., resolution, luminosity and dimensions) allows the simultaneous display of at least two images or image streams of adequate size and quality for diagnostic or therapeutic applications in hospital. In one example, a monitor having a resolution of 4 M pixels to over 8 M pixels and a screen size from 30″ to 64″ may be suitable for use as a large-format display unit in a hospital.

Selecting a workflow starts the associated program. This determines and/or sets for example an optimized image configuration for the workflow for display on the large-format display unit. An image configuration may include the selection and arrangement of elements (e.g., images and information) for display on the large-format display unit. An image configuration may include a number of images.

Workflow-related or process-oriented information may be displayed on the large-format display unit, for example, treatment acts to be carried out or status information (e.g. status information relating to devices or error messages). The treating physician may input additional information for display on the large-format display unit or to modify, adjust or delete displayed information using an input unit.

In one embodiment, a program is configured to adjust the display on the large-format display unit according to an input of an input unit (e.g., operating console). The input unit may correspond to the device on which the programs are stored and run. With regard to the input, different acts of the workflow (e.g. treatment steps or examination steps) may be identified on the large-format display unit and for the treating physician to adjust the display on the large-format display unit after the end of an act by inputting information identifying the next act to be implemented or by depressing a key or key combination. The program may control the display on the large-format display unit to adjust the workflow act to be carried out. Accordingly, this may be semi-automatic control of the display according to the workflow. It is also possible for the physician to input information about his/her position (e.g. the side of the patient table from which he/she is working) so that the program can adjust the display.

In one embodiment, fully-automatic control of at least some of the workflow-related display adjustments is provided. Position information relating to a medical device or the treating physician is automatically captured, the position information is transferred to the program, and the program adjusts the display according to the position information. For example, acts of the workflow correspond to different positions of a medical device. In one example, anesthesia and then a surgical intervention are carried out as two separate acts during a treatment. Movement of the surgical device from the rest position may be the trigger for adjustment of the display for the second act, the surgical intervention. This example is only intended for the purposes of illustration. Generally the processes are more complex, which can also result in more complex trigger mechanisms. For example, it can be expedient to make the adjustment dependent on a number of position information items, to ensure, for example, (by verifying additional position information) that the preceding act has been completed (e.g. medical device A is in the rest position and medical device B is in a deployment position). Another embodiment relates to the automatic capturing (e.g. by sensors or a video camera) of position information relating to the treating physician (e.g. the direction from which the physician treats the patient). The position information is then transferred to the program and triggers an adjustment of the display.

### BRIEF DESCRIPTION OF THE DRAWINGS

FIG. 1 shows a first image configuration;

FIG. 2 shows a second image configuration;

FIG. 3 shows one embodiment of a display on a large-format display unit; and

FIG. 4 shows one embodiment of a medical display system;

### DETAILED DESCRIPTION

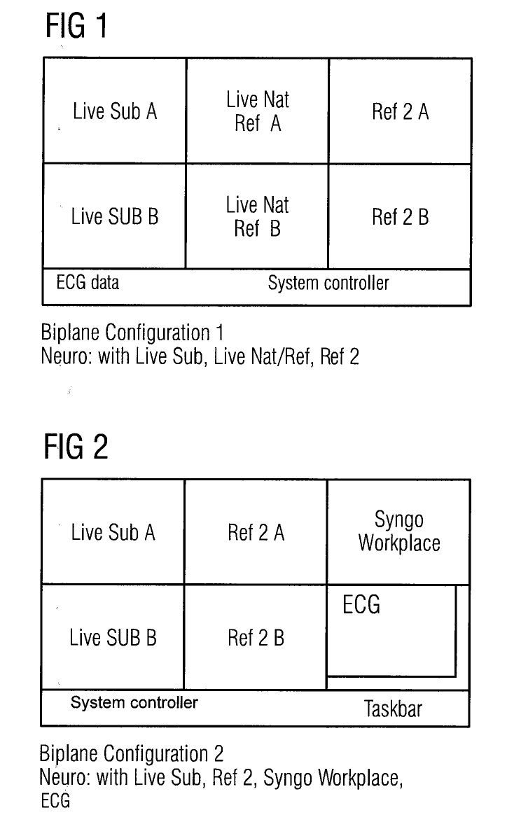

By calling up a program corresponding to a workflow, an image configuration may be initially predetermined, which has been put together for optimal support for the workflow. Examples of such image configurations are shown in FIG. 1 and FIG. 2.

FIG. 1 shows an image configuration, in which six images are displayed on the large-format display unit. The images identified as Life Sub A, Life Sub B, Life Nat Ref A, Live Nat Ref B, Ref 2 A, and Ref 2 B. Life Sub A and Life Sub B are subtraction images. Life Nat Ref A and Live Nat Ref B are unprocessed recordings. Ref 2 A and Ref 2 B are reference images.

Such an image composition is used, for example, during an angiography examination. In angiography, vessels are examined using x-ray recordings. A radioactive contrast agent is introduced into the vessels and an x-ray recording is taken. A contrast is obtained by using an x-ray recording before the application of the contrast agent to remove the background of the recording, so that only the vessels can still be seen (e.g., a differential image). A recording before administration of the contrast agent (e.g., Ref 2 A and Ref 2 B) is superimposed with the recording after administration of the contrast agent (e.g., Life Nat Ref A and Live Nat Ref B) to remove the background, in order to generate a differential recording (e.g., Life Sub A and Life Sub B), in which essentially only the vessels are still shown.

In addition to the image configuration, a strip may be provided at the lower edge of the large-format display unit in which ECG data and system control information are shown. The image configuration shown in FIG. 2 differs in that the two images on the right side in FIG. 1 have been moved into the center and system-related information (e.g., Syngo Workplace) and ECG data is shown or displayed in the place of the two images on the right side in FIG. 1. The image configurations in FIG. 1 and FIG. 2 can also be used as an alternative for the same workflow. The physician is then able to choose between two (or more) options for a configuration suitable for the workflow.

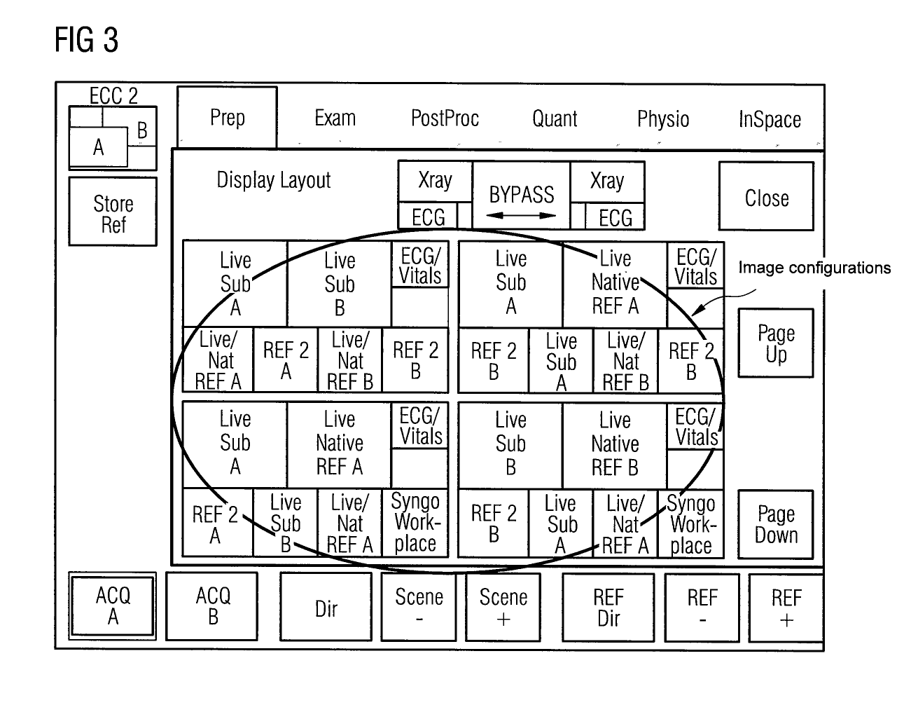

FIG. 3 shows the display of an image configuration on a large-format display unit. On the left of FIG. 3 are four images showing vessels recording using angiography. On the right of FIG. 3 is information relating to the workflow, for example, ECG curves.

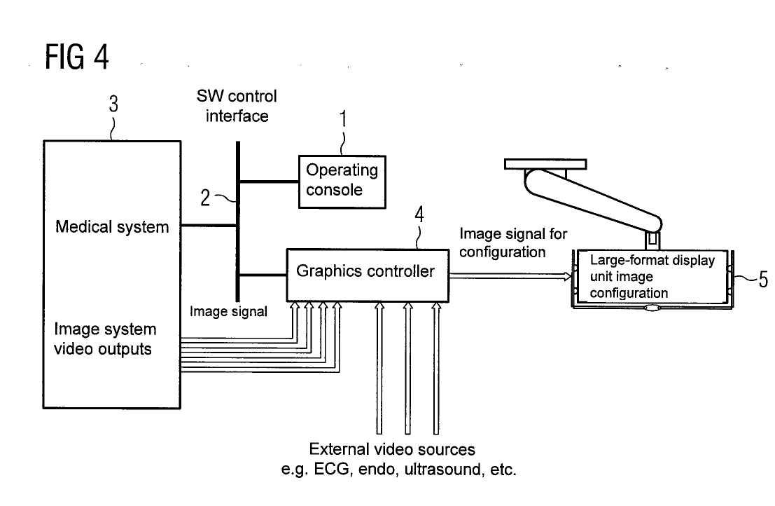

FIG. 4 shows a system for displaying image configurations on a large-format display unit. An operating console 1, which is connected by a software control interface 2 to a medical system 3 and a graphics controller 4, can be used to select image configurations to be displayed on a large-format display unit 5. The operating console 1 may be used to operate and/or control the medical system 3. The medical system 3 is, for example, an angiography unit, which is used to produce angiography images, for example. The images are transferred to the graphics controller 4. A number of inputs are provided in order to be able to transmit a number of images (e.g. reference images and differential images) to be displayed from the angiography unit separately to the graphics controller 4.

The input device, for example, the operating console 1, is used to select a workflow. It is possible to select organs or parts of the body, for example, by way of the input device, causing an associated program (e.g. organ program) to be started. A workflow corresponds to the program and/or the examination or treatment of the organ or part of the body. The display on the large-format display unit 5 may be controlled by the program to support the workflow. An image configuration appropriate for the workflow is determined for display on the large-format display 5. The image configuration is transferred to the graphics controller 4. The graphics controller 4 includes inputs to external video sources, for example, ECG, endoscopy, or ultrasound. The external video sources may be referenced by the image configuration. The external video sources may be selected for display on the large-format display unit 5. The graphics controller 4 represents an adjustment device, which composes (generates) an image according to the selected image configuration and in some instances other control information, and transmits a corresponding image signal to the large-format display unit 5.

Additional control information may be specified by a user input at the operating console 1. Another possibility is the automatic generation of control information for the composition of the image by the graphics controller 4 by the program, which is also responsible for adjusting the image configuration displayed on the large-format display unit according to the workflow and/or the treatment or examination process.

While the invention has been described above by reference to various embodiments, it should be understood that many changes and modifications can be made without departing from the scope of the invention. For example, although the embodiments were discussed in conjunction with a particle therapy system, the same problems and solutions arise in photon therapy as well. It is therefore intended that the foregoing detailed description be regarded as illustrative rather than limiting, and that it be understood that it is the following claims, including all equivalents, that are intended to define the spirit and scope of this invention.

1. A device for controlling a display of medical images on a large-format display, the device comprising:
a program that is assigned to a medical workflow, program being operable to control the display on the large-format display unit according to the medical workflow,
wherein the program may be selected from a plurality of programs by selecting the medical workflow.

2. The device as claimed in claim 1, wherein the program determines an image configuration suitable for the medical workflow to be displayed on the large-format display.

3. The device as claimed in claim 1, wherein the program updates information displayed on the large-format display.

4. The device as claimed in claim 1, wherein the program adjusts the display on the large-format display based on position information relating to a treating physician position or a medical device position.

5. The device as claimed in claim 4, wherein the position information is automatically captured and transferred to the device.

6. The device as claimed in claim 1, further comprising an input device.

7. A method for controlling a display of medical images on a large-format display, the method including:
providing a program that is assigned to a medical workflow,
selecting a medical workflow,
starting the program based on the selected medical workflow, and
controlling the display on the large-format display unit according to the selected medical workflow using the program.

8. The method as claimed in claim 7, further comprising determining an image configuration to be displayed on the large-format display using the program.

9. The method as claimed in claim 7, further comprising updating information displayed on the large-format display using the program.

10. The method as claimed in claim 7, further comprising:
inputting position information relating to a treating physician position or a medical device position, and
adjusting the display on the large-format display according to the position information.

11. The method as claimed in claim 10, further comprising capturing the position information automatically and transferring the position information to the program.

12. The device as claimed in claim 1, wherein the program is a computer program.

13. The device as claimed in claim 6, wherein the input device is used to input position information relating to a position of a physician or a position of a medical device.

14. The device as claimed in claim 2, wherein the program updates information displayed on the large-format display.

15. The device as claimed in claim 2, wherein the program adjusts the display on the large-format display based on position information relating to a treating physician position or a medical device position.

16. The method as claimed in claim 7, wherein the program is a computer program.

17. The method as claimed in claim 8, further comprising updating information displayed on the large-format display using the program.

18. The method as claimed in claim 8, further comprising:
inputting position information relating to a treating physician position or a medical device position, and
adjusting the display on the large-format display according to the position information.

19. The method as claimed in claim 18, further comprising capturing the position information automatically and transferring the position information to the program.
